(19) United States
(12) Patent Application Publication
(10) Pub. No.: US 2026/0254870 A1
(43) Pub. Date: Aug. 27, 2026

(54) PEER-TO-PEER COMMUNICATION BETWEEN DEVICES WITH COHERENT FABRIC BYPASS

(71) Applicant: QUALCOMM Incorporated, San Diego, CA (US)

(72) Inventors: Ramacharan SUNDARARAMAN, San Jose, CA (US); Ravikiran KAIDALA LAKSHMAN, Fremont, CA (US)

(21) Appl. No.: 19/064,293

(22) Filed: Feb. 26, 2025

(51) Int. Cl. H04L 67/1074; G06F 15/78

(52) U.S. Cl. CPC H04L 67/1074; G06F 15/7825

(57) ABSTRACT

Aspects of the disclosure provide techniques for utilizing peer-to-peer (P2P) bypass techniques to reduce oversubscription of a coherent fabric due to P2P traffic and the impact on other initiators of the data traffic. The techniques can lower the latency, improve bandwidth, and lower buffering cost for peripheral component interconnect express (PCIe) components that communicate P2P traffic.

### TECHNICAL FIELD

The technology discussed below relates generally to peer-to-peer (P2P) communication between data communication devices, and more particularly, to techniques for bypassing a coherent fabric between the data communication devices.

### INTRODUCTION

In many computer systems, peripheral devices can communicate with the central processing unit (CPU) and with one another over a peripheral component bus, such as the peripheral component interconnect express (PCIe) interface and the like. For example, certain devices may include processing, communications, storage, and/or display devices that interact with one another through one or more high-speed interfaces (e.g., PCIe). Some of these devices, including synchronous dynamic random-access memory (SDRAM), may be capable of providing or consuming data and control information at processor clock rates. Other devices, e.g., display controllers, may use variable amounts of data at relatively low video refresh rates.

In a computer system, peer-to-peer (P2P) communication enables two devices (e.g., PCIe devices) to directly transfer data between each other without using a host of the computer system as temporary storage. For example, a PCIe topology can have multiple PCIe switches and devices (e.g., Endpoints). P2P communication enables PCIe devices, for example graphical processing units (GPU), storage cards, network interface cards (NIC) etc., to send traffic between themselves with less intervention from the host for various workloads.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

Aspects of the disclosure provide techniques for utilizing peer-to-peer (P2P) bypass techniques to reduce oversubscription of a coherent fabric due to P2P traffic and the impact on other initiators of the data traffic. The techniques can lower the latency, improve bandwidth, and lower buffering cost for peripheral component interconnect express (PCIe) components that communicate P2P traffic. The disclosed techniques can maintain the P2P traffic maximum payload size, thereby maintaining payload efficiency on PCIe traffic. The techniques enable P2P traffic to bypass a coherent fabric in various use cases.

One aspect of the disclosure provides a method for peer-to-peer (P2P) data communication. The method includes receiving a data packet from a first device. The method determines whether an address associated with a second device is within a P2P address range. The method, in response to determining that the second device is within the P2P address range, send the data packet to the second device bypassing a coherent fabric.

One aspect of the disclosure provides an apparatus for data communication. The apparatus includes one or more memories and one or more processors connected to the one or more memories. The one or more processors are configured to receive a data packet from a first device. The one or more processors are configured to determine whether a second device is within a P2P address range. The one or more processors are configured to, in response to determining that the second device is within the P2P address range, send the data packet to the second device bypassing a coherent fabric.

One aspect of the disclosure provides an apparatus for data communication. The apparatus includes means for receiving a data packet from a first device. The apparatus includes means for determining whether a second device is within a P2P address range. The apparatus includes means for sending the data packet to the second device bypassing a coherent fabric in response to determining that the second device is within the P2P address range.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 is a block diagram of an exemplary computing architecture using a peripheral device interface according to aspects of the disclosure.

FIG. 2 is a block diagram of a system including a host system and an endpoint device system according to aspects of the present disclosure.

FIG. 3 is a block diagram of a peripheral component interconnect express (PCIe) system including a peer-to-peer (P2P) coherent fabric bypass mechanism according to aspects of the disclosure.

FIG. 4 is a block diagram of an input-output (I/O) subsystem including a P2P bypass bridge according to aspects of the disclosure.

FIG. 5 is a diagram illustrating an exemplary confined P2P address range configuration according to aspects of the disclosure.

FIG. 6 is a diagram illustrating an exemplary local P2P address range configuration according to aspects of the disclosure.

FIG. 7 is a diagram illustrating an exemplary remote P2P address range configuration according to aspects of the disclosure.

FIG. 8 is a flow chart illustrating an exemplary process for processing PCIe P2P traffic according to aspects of the disclosure.

FIG. 9 is a block diagram of a P2P bypass bridge according to aspects of the disclosure.

FIG. 10 is a flow diagram illustrating a method for P2P communication between PCIe devices according to aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

Aspects of the disclosure provide techniques for utilizing peer-to-peer (P2P) bypass techniques to reduce oversubscription of a coherent fabric due to P2P traffic and the impact on other initiators of the data traffic. The techniques can lower the latency, improve bandwidth, and lower buffering cost for peripheral component interconnect express (PCIe) components that communicate P2P traffic. The disclosed techniques can maintain the P2P traffic maximum payload size, thereby maintaining payload efficiency on PCIe traffic. The techniques enable P2P traffic to bypass a coherent fabric in various use cases.

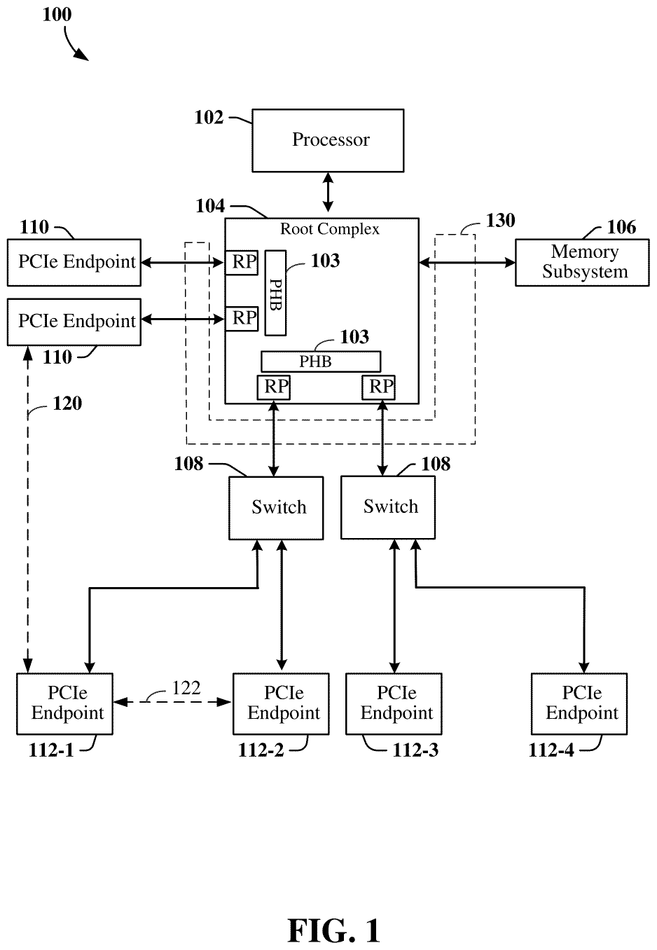

FIG. 1 is a block diagram of a computing architecture 100 using a peripheral device interface according to some aspects of the disclosure. One example of peripheral device interface is the PCIe interface. For example, the computing architecture 100 can operate using multiple high-speed PCIe interface serial links. A PCIe interface can use separate serial links to connect each device to a processor 102. In the computing architecture 100, a root complex 104 can connect the processor 102 to memory devices, e.g., the memory subsystem 106, and one or more PCIe devices (e.g., PCIe switch circuit 108, PCIe endpoint (EP) 110). A host of the computer architecture 100 can include the processor 102, the memory subsystem 106, and the root complex 104. In some instances, the PCIe switch circuit 108 can include cascaded switch devices. One or more PCIe EP devices 110 may be connected directly to the root complex 104, while other PCIe EP devices (e.g., EPs 112-1, 112-2, 112-3, 112-4) may be connected to the root complex 104 indirectly, for example, through the PCIe switch circuit 108. In some aspects, the root complex 104 may be connected to the processor 102 using a proprietary local bus interface or a standards defined local bus interface. The root complex 104 may control configuration and data transactions through the PCIe interfaces and may generate transaction requests for the processor 102. In some examples, the root complex 104 can be implemented in the same integrated circuit (IC) device that includes the processor 102. The root complex 104 can provide one or more PCIe ports (e.g., root ports (RP)) for connecting PCIe devices. These RP's may be associated with one or more PCIe host bridges (PHB) (e.g., PHB 103).

The root complex 104 may control communication between the processor 102 and the memory subsystem 106. The root complex 104 also controls communication between the processor 102 and PCIe EPs (e.g., EPs 110, 112-1, 112-2, 112-3, 112-4, etc.) The PCIe interface can support full-duplex communication between any two EPs, with no inherent limitation on concurrent access across multiple EPs through the PCIe fabric. Data packets may carry information through any PCIe link. In a multi-lane PCIe link, packet data may be striped across multiple lanes. The number of lanes in the multi-lane link may be negotiated during device initialization and may be different for different EPs. In some aspects, the computing architecture 100 can use a coherent fabric 130 to enable data (e.g., cache data) coherence across the computing architecture 100 for memory transactions involving the processor, memory, and PCIe devices (e.g., EPs). In a PCIe system, the coherent fabric forms an interconnect architecture that ensures data/cache coherence across different devices, processors, and memory systems. However, routing data traffic through the coherent fabric can increase latency.

In some aspects, the computing architecture 100 can provide a mechanism that bypasses the coherent fabric for certain data traffic or PCIe transactions. For example, PCIe traffic 120 between the EP 110 and EP 112-1 can bypass the coherent fabric under certain conditions, and similarly, PCIe traffic 122 between the EP 112-1 and EP 112-2 can bypass the coherent fabric under certain conditions. The bypass mechanism will be described in more detail below.

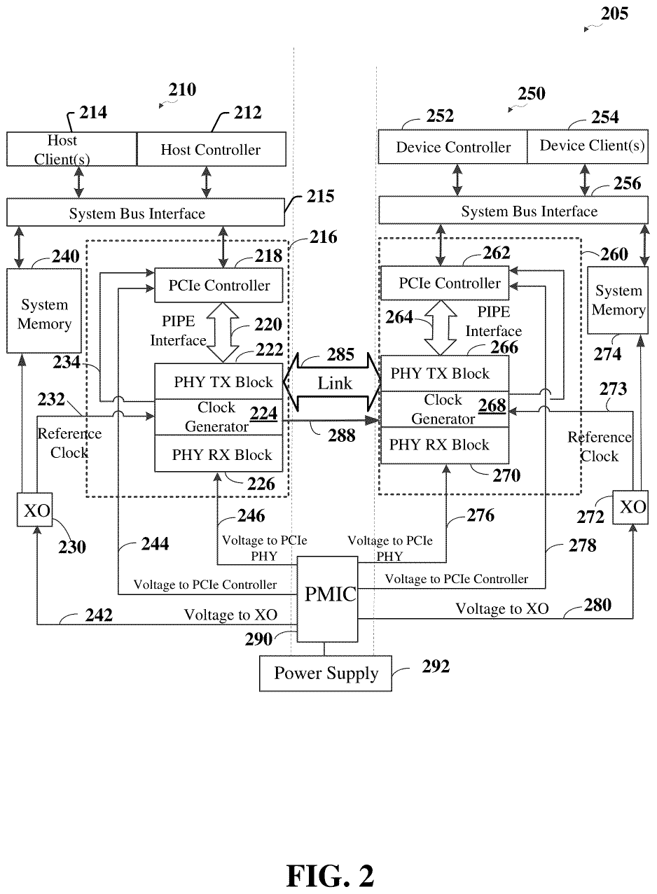

FIG. 2 is a block diagram of an exemplary PCIe system in which aspects of the present disclosure may be implemented. The system 205 includes a host system 210 and an endpoint device system 250, which may be the same as the host and endpoints of FIG. 1. The host system 210 may be integrated on a first chip (e.g., system on a chip or SoC), and the endpoint device system 250 may be integrated on a second chip. Alternatively, the host system and/or endpoint device system may be integrated in first and second packages, e.g., SiP, first and second system boards with multiple chips, or in other hardware or any combination. In this example, the host system 210 and the endpoint device system 250 are coupled by a PCIe link 285.

The host system 210 includes one or more host clients 214. Each of the one or more host clients 214 may be implemented on a processor executing software that performs the functions of the host clients 214 discussed herein. For the example of more than one host client, the host clients may be implemented on the same processor or different processors. The host system 210 also includes a host controller 212, which may perform root complex functions. The host controller 212 may be implemented on a processor executing software that performs the functions of the host controller 212 discussed herein.

The host system 210 includes a PCIe interface circuit 216, a system bus interface 215, and a host system memory 240. The system bus interface 215 may interface the one or more host clients 214 with the host controller 212, and interface each of the one or more host clients 214 and the host controller 212 with the PCIe interface circuit 216 and the host system memory 240. The PCIe interface circuit 216 provides the host system 210 with an interface to the PCIe link 285. In this regard, the PCIe interface circuit 216 is configured to transmit data (e.g., from the host clients 214) to the endpoint device system 250 over the PCIe link 285 and receive data from the endpoint device system 250 via the PCIe link 285. The PCIe interface circuit 216 includes a PCIe controller 218, a physical interface for PCI Express (PIPE) interface 220, a physical (PHY) transmit (TX) block 222, a clock generator 224, and a PHY receive (RX) block 226. The PIPE interface 220 provides a parallel interface between the PCIe controller 218 and the PHY TX block 222 and the PHY RX block 226. The PCIe controller 218 (which may be implemented in hardware) may be configured to perform transaction layer, data link layer, and flow control functions (e.g., flow control based on PCIe specification), as described further below. The flow control functions can selectively retransmit (replay) only packets (e.g., transaction layer packet (TLP)) for which negative acknowledgment (NACK) is received (i.e., lost or corrupted during transmission), instead of replaying all the packets present in a replay buffer of the transmitter. For example, the replay buffer may be implemented using the system memory 240/260 and/or included in the PHY TX block 222/266.

The host system 210 also includes an oscillator (e.g., crystal oscillator or “XO”) 230 configured to generate a reference clock signal 232. The reference clock signal 232 may have a frequency of 19.2 MHz in one example, but is not limited to such frequency. The reference clock signal 232 is input to the clock generator 224 which generates multiple clock signals based on the reference clock signal 232. In this regard, the clock generator 224 may include a phase locked loop (PLL) or multiple PLLs, in which each PLL generates a respective one of the multiple clock signals by multiplying up the frequency of the reference clock signal 232.

The endpoint device system 250 includes one or more device clients 254. Each device client 254 may be implemented on a processor executing software that performs the functions of the device client 254 discussed herein. For the example of more than one device client 254, the device clients 254 may be implemented on the same processor or different processors. The endpoint device system 250 also includes a device controller 252. The device controller 252 may be configured to receive bandwidth request(s) from one or more device clients, and determine whether to change the number of transmit lines or the number of receive lines based on bandwidth requests. The device controller 252 may be implemented on a processor executing software that performs the functions of the device controller.

The endpoint device system 250 includes a PCIe interface circuit 260, a system bus interface 256, and endpoint system memory 274. The system bus interface 256 may interface the one or more device clients 254 with the device controller 252, and interface each of the one or more device clients 254 and device controllers 252 with the PCIe interface circuit 260 and the endpoint system memory 274. The PCIe interface circuit 260 provides the endpoint device system 250 with an interface to the PCIe link 285. In this regard, the PCIe interface circuit 260 is configured to transmit data (e.g., from the device client 254) to the host system 210 (also referred to as the host device) over the PCIe link 285 and receive data from the host system 210 via the PCIe link 285. The PCIe interface circuit 260 includes a PCIe controller 262, a PIPE interface 264, a PHY TX block 266, a PHY RX block 270, and a clock generator 268. The PIPE interface 264 provides a parallel interface between the PCIe controller 262 and the PHY TX block 266 and the PHY RX block 270. The PCIe controller 262 (which may be implemented in hardware) may be configured to perform transaction layer, data link layer, and control flow functions.

The host system memory 240 and the endpoint system memory 274 at the endpoint may be configured to contain registers for the status of each transmit line and receive line of the PCIe link 285. The transmit lines may be configured as differential transmit line pairs and the receive lines may be configured as differential receive line pairs.

The endpoint device system 250 also includes an oscillator (e.g., crystal oscillator) 272 configured to generate a stable reference clock signal 273 for the endpoint system memory 274 and the clock generator 268. In the example in FIG. 2, the clock generator 224 at the host system 210 is configured to generate a stable reference clock signal, which is forwarded to the endpoint device system 250 via a differential clock line 288 by the PHY RX block 226. At the endpoint device system 250, the PHY RX block 270 receives the endpoint (EP) reference clock signal on the differential clock line 288, and forwards the EP reference clock signal to the clock generator 268. The EP reference clock signal may have a frequency of 100 MHz, but is not limited to such frequency. The clock generator 268 can be configured to generate multiple clock signals based on the EP reference clock signal from the differential clock line 288, as discussed further below. In this regard, the clock generator 268 may include multiple phase-locked loops (PLLs), in which each PLL generates a respective one of the multiple clock signals by multiplying up the frequency of the EP reference clock signal.

The system 205 also includes a power management integrated circuit (PMIC) 290 coupled to a power supply 292 e.g., mains voltage, a battery, or other power source. The PMIC 290 is configured to convert the voltage of the power supply 292 into multiple supply voltages (e.g., using switch regulators, linear regulators, or any combination thereof). In this example, the PMIC 290 generates voltages 242 for the oscillator 230, voltages 244 for the PCIe controller 218, and voltages 246 for the PHY TX block 222, the PHY RX block 226, and the clock generator 224. The voltages 242, 244, and 246 may be programmable, in which the PMIC 290 is configured to set the voltage levels (corners) of the voltages 242, 244, and 246 according to instructions (e.g., from the host controller 212).

The PMIC 290 also generates a voltage 280 for the oscillator 272, a voltage 278 for the PCIe controller 262, and a voltage 276 for the PHY TX block 266, the PHY RX block 270, and the clock generator 268. The voltages 280, 278, and 276 may be programmable, in which the PMIC 290 is configured to set the voltage levels (corners) of the voltages 280, 278, and 276 according to instructions (e.g., from the device controller 252). The PMIC 290 may be implemented on one or more chips. Although the PMIC 290 is shown as one PMIC in FIG. 2, it is to be appreciated that the PMIC 290 may be implemented by two or more PMICs. For example, the PMIC 290 may include a first PMIC for generating voltages 242, 244, and 246 and a second PMIC for generating voltages 280, 278, and 276. In this example, the first and second PMICs may both be coupled to the same power supply 292 or to different power supplies.

In operation, the PCIe interface circuit 216 on the host system 210 may transmit data from the one or more host clients 214 to the endpoint device system 250 via the PCIe link 285. The data from the one or more host clients 214 may be directed to the PCIe interface circuit 216 according to a PCIe map set up by the host controller 212 during initial configuration, sometimes referred to as Link Initialization, when the host controller negotiates bandwidth for the link. At the PCIe interface circuit 216, the PCIe controller 218 may perform transaction layer and data link layer functions on the data e.g., packetizing the data, generating error correction codes to be transmitted with the data, etc.

The PCIe controller 218 outputs the processed data to the PHY TX block 222 via the PIPE interface 220. The processed data includes the data from the one or more host clients 214 as well as overhead data (e.g., packet header, error correction code, etc.). In one example, the clock generator 224 may generate a clock 234 for an appropriate data rate or transfer rate based on the reference clock signal 232, and input the clock 234 to the PCIe controller 218 to time operations of the PCIe controller 218. In this example, the PIPE interface 220 may include a 22-bit parallel bus that transfers 22-bits of data to the PHY TX block in parallel for each cycle of the clock 234. At 250 MHz this translates to a transfer rate of approximately 8 GT/s.

The PHY TX block 222 serializes the parallel data from the PCIe controller 218 and drives the PCIe link 285 with the serialized data. In this regard, the PHY TX block 222 may include one or more serializers and one or more drivers. The clock generator 224 may generate a high-frequency clock for the one or more serializers based on the reference clock signal 232.

At the endpoint device system 250, the PHY RX block 270 receives the serialized data via the PCIe link 285, and deserializes the received data into parallel data. In this regard, the PHY RX block 270 may include one or more receivers and one or more deserializers. The clock generator 268 may generate a high-frequency clock for the one or more deserializers based on the EP reference clock signal. The PHY RX block 270 transfers the deserialized data to the PCIe controller 262 via the PIPE interface 264. The PCIe controller 262 may recover the data from the one or more host clients 214 from the deserialized data and forward the recovered data to the one or more device clients 254.

On the endpoint device system 250, the PCIe interface circuit 260 may transmit data from the one or more device clients 254 to the host system memory 240 via the PCIe link 285. In this regard, the PCIe controller 262 at the PCIe interface circuit 260 may perform transaction layer and data link layer functions on the data e.g., packetizing the data, generating error correction codes to be transmitted with the data, etc. The PCIe controller 262 outputs the processed data to the PHY TX block 266 via the PIPE interface 264. The processed data includes the data from the one or more device clients 254 as well as overhead data (e.g., packet header, sequence number, error correction code, etc.). An example of error correction code is cyclic redundancy check (CRC). In one example, the clock generator 268 may generate a clock based on the EP reference clock through a differential clock line 288, and input the clock to the PCIe controller 262 to control time operations of the PCIe controller 262.

The PHY TX block 266 serializes the parallel data from the PCIe controller 262 and drives the PCIe link 285 with the serialized data. In this regard, the PHY TX block 266 may include one or more serializers and one or more drivers. The clock generator 268 may generate a high-frequency clock for the one or more serializers based on the EP reference clock signal.

At the host system 210, the PHY RX block 226 receives the serialized data via the PCIe link 285, and deserializes the received data into parallel data. In this regard, the PHY RX block 226 may include one or more receivers and one or more deserializers. The clock generator 224 may generate a high-frequency clock for the one or more deserializers based on the reference clock signal 232. The PHY RX block 226 transfers the deserialized data to the PCIe controller 218 via the PIPE interface 220. The PCIe controller 218 may recover the data from the one or more device clients 254 from the deserialized data and forward the recovered data to the one or more host clients 214.

The host clients 214, the host controller 212, the device controller 252 and the device clients 254 discussed above may each be implemented with a controller or processor configured to perform the functions described herein by executing software including code for performing the functions. The software may be stored on a non-transitory computer-readable storage medium, e.g. a RAM, a ROM, an EEPROM, an optical disk, and/or a magnetic disk, shows as host system memory 240, endpoint system memory 274, or as another memory.

Peer-to-peer (P2P) communication is a feature that enables two peer devices (e.g., PCIe EPs of FIG. 1) to directly transfer data between each other without using a host (e.g., processor 102 and memory 106 of FIG. 1) as temporary storage. PCIe devices (e.g., graphical processing units (GPU), storage cards, network interface cards (NIC), etc.) can send P2P traffic between themselves with less intervention from the host for certain workloads. For example, artificial intelligent (AI) workloads at a GPU can send traffic to a peer GPU or access a data storage or a NIC with little or no intervention from the host. However, in virtualized systems, there is typically a need for one or more stages of address translation that can be performed by a system memory management unit (SMMU) or input-output (IO) memory management unit (IOMMU), generically referred to as memory management unit (MMU). Further, the MMU can additionally implement access control policies. Therefore, the P2P traffic can still get redirected to the host.

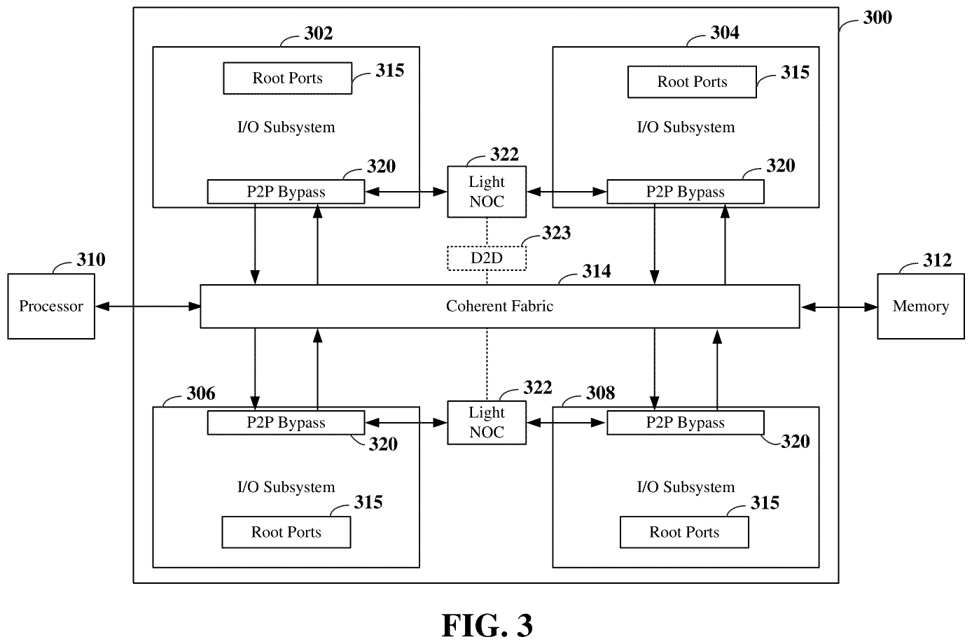

FIG. 3 is a block diagram illustrating a PCIe system 300 with a peer-to-peer (P2P) coherent fabric bypass capability according to some aspects of the disclosure. The PCIe system 300 may be implemented using any of the PCIe devices shown in FIGS. 1 and 2. The PCIe system 300 can be implemented using the root complex 104 of FIG. 1 that interconnects with one or more processors (e.g., a processor 310) and one or more memories (memory 312). One example of memory 312 is double data rate (DDR) memory. The PCIe system 300 can have multiple input-output (I/O) subsystems (e.g., I/O subsystems 302, 304, 306, and 308) that are interconnected with the processor 310 and the memory 312 by a coherent fabric 314. In some examples, the I/O subsystem can be a PCIe subsystem that includes one or more root ports 315 that can be used to connect PCIe devices. The coherent fabric can include software and/or hardware components that are configured to ensure cache/data coherence across multiple devices, for example, processors, memory subsystems, and PCIe devices. The coherent fabric enables these components to share and access the memory while maintaining data consistency across different caches and memory spaces. Each I/O subsystem can include one or more PCIe switches and EPs similar to those shown in FIGS. 1 and 2.

When P2P traffic passes through a root complex, significant latency can be incurred due to the coherent fabric managing inbound P2P traffic, memory mapped IO (MMIO) traffic, and memory subsystem traffic. The added latency can affect the bandwidth for other PCIe devices and non-P2P traffic. In some cases, P2P traffic can oversubscribe the network-on-chip (NOC) components, and potentially affect other traffic initiators in the PCIe system. Pending snoops in a home node (e.g., processor 310) can also cause backpressure on P2P traffic. Snooping at a home node refers to the process of checking whether a copy of a specific memory block or cache line is stored in a cache (either local or remote) before performing a memory operation (e.g., read or write). The home node uses snooping to ensure cache coherence across multiple devices that may share and modify the same memory regions. The coherent fabric 314 can operate on cache-line granularity (e.g., 64B). Therefore, routing the P2P traffic through the coherent fabrics may segment inbound P2P traffic into multiple outbound transactions that reduces the efficiency on PCIe traffic and/or needs a re-order buffer to coalesce the segmented traffic data back together. In some cases, when the PCIe or I/O subsystems are on separate chiplets, P2P traffic between chiplets can add further latency and reduce available bandwidth between chiplets.

In some aspects, the I/O subsystem can include a P2P bypass bridge 320 that enables P2P traffic to bypass the coherent fabric 314 in some cases, thus lowering the latency of P2P traffic and reducing the load on the coherent fabric such that it can have more capacity to handle non-P2P transactions. In some aspects, the PCIe system 300 can route P2P traffic between PCIe devices in different I/O subsystems using a light-weight network on chip (NOC) (e.g., two NOCs 322 shown in FIG. 3). The light-weight NOC acts as an interconnect fabric to send and receive P2P traffic between I/O subsystems and bypass the coherent fabric 314. The light-weight NOC can be optimized specifically for handling P2P communication between PCIe devices (e.g., EPs) without involving the processor 310 and/or memory subsystem (e.g., memory 312). Unlike the light-weight NOC 322, a typical NOC (not shown in FIG. 3) designed to handle all PCIe transactions needs to support not only P2P PCIe traffic but also CPU-initiated transactions, memory accesses, interrupt handling, etc. A typical NOC manages communication between the PCIe root complex, processor, memory controllers, and PCIe devices, facilitating a broader range of data transfers such as DMA, interrupts, and memory read/write operations. In contrast, the light-weight NOC 322 supports non-coherent semantics that can be used to connect the PCIe P2P bypass bridges 320 including crossing across simplified D2D interconnects 323 when these PCIe subsystems are on separate chiplets or devices. The light-weight NOCs and their associated D2D interconnects enable P2P traffic to completely bypass the coherent fabric.

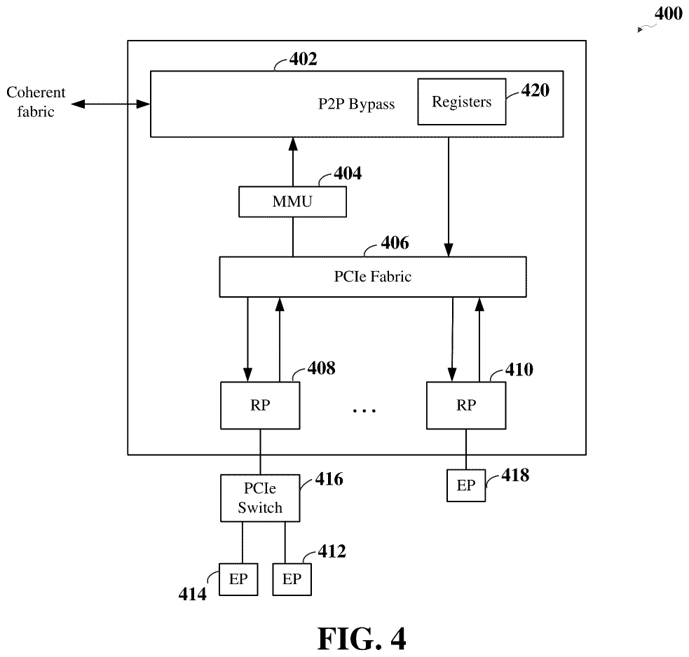

FIG. 4 is a block diagram illustrating an input-output (I/O) subsystem 400 including a P2P bypass bridge according to some aspects of the disclosure. The I/O subsystem 400 may be any of the I/O subsystems 302, 304, 306, and 308 described above in relation to FIG. 3. In some examples, the I/O subsystem 400 can be a PCIe subsystem. The I/O subsystem 400 includes various components, for example, a P2P bypass bridge 402, a memory management unit (MMU) 404, a PCIe fabric 406, and one or more PCIe RPs (e.g., two RPs 408 and 410 shown in FIG. 4). A PCIe EP can be connected to a RP directly or via a PCIe switch. For example, EPs 412 and 414 are connected to RP 408 via a PCIe switch 416, and EP 418 is connected directly to RP 410.

PCIe traffic is bidirectional. In the inbound direction, the data traffic can go from one or more RPs to the PCIe fabric 406, which arbitrates the data traffic across multiple RPs. The data traffic can originate from an EP connected to the RP. The MMU 404 performs the address translation from virtual address to physical address and then sends the data to the coherent fabric (e.g., coherent fabric 314 of FIG. 3) if needed. The coherent fabric can perform directory lookup, further decoding, and send the data traffic accordingly either to memory or the corresponding PCIe subsystem (e.g., IO subsystems of FIG. 3) of the destination EP for P2P traffic. For the PCIe outbound traffic (from PCIe fabric towards EPs), the MMU 404 and/or PCIe fabric 406 can perform further decoding and send it to the appropriate RP and associated EP.

In some aspects, the PCIe P2P bypass bridge 402 can capture and record the memory details (e.g., memory range limits and apertures) of connected devices (e.g., PCIe EPs 412, 414, and 418). For example, the P2P bypass bridge can be configured to capture the information of PCIe devices (e.g. EPs) when the system is setting up and identify devices on the PCIe bus (a process known as device enumeration). With the memory location information, the P2P bypass bridge can help manage data flow (e.g., P2P traffic) between PCIe devices (e.g., EPs) more effectively.

During runtime, if the physical address of inbound PCIe traffic falls in the memory space region of any of the RPs in the same subsystem 400, the P2P bypass bridge 402 can redirect the PCIe traffic to a downstream RP connected to the destination EP without sending the PCIe traffic to the coherent fabric (e.g., coherent fabric 314 of FIG. 3). In this case, the PCIe traffic bypasses the coherent fabric. For example, the inbound PCIe traffic can include P2P traffic from a source EP (e.g., EP 412) to a destination EP (e.g., EP 414 or EP 418). Based on the known memory space information of EPs, the P2P bypass bridge 402 can determine that both the source and destination EPs are located in the same I/O subsystem 400. Therefore, the P2P bypass bridge can redirect the inbound PCIe traffic to outbound PCIe traffic without using the coherent fabric. In some aspects, when there are multiple PCIe subsystems each with a set of RPs (e.g., root ports 315 of FIG. 3), the PCIe P2P bypass bridge 402 can use one or more registers 420 to capture all the memory space range information and apertures of those PCIe subsystems, for example, during PCIe device enumeration.

In some aspects, the above-described P2P bypass bridge and techniques can be applied to various types of P2P memory range configurations. There are three types of P2P memory ranges discussed herein, referred to as a confined P2P address range, a local P2P address range, and a remote P2P address range.

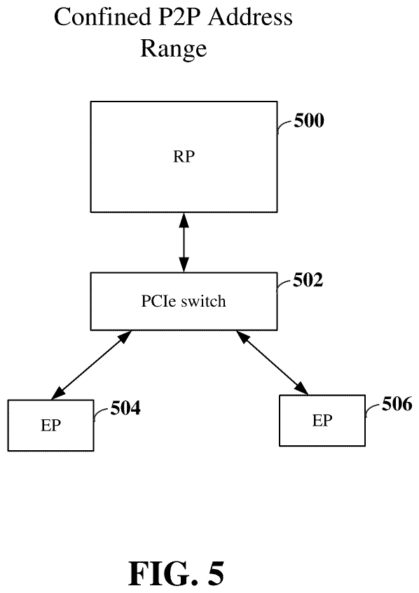

FIG. 5 is a diagram illustrating an exemplary confined P2P address range configuration according to some aspects of the disclosure. A confined P2P address range maps to a memory space behind a single RP 500 and a PCIe switch 502. The confined P2P address range refers to a specific memory address space that is used for P2P communication between devices connected through one or more switches 502 beneath the same RP 500. For example, EP 504 and EP 506 are within a confined P2P address range of each other between these EPs are connected to the same RP. In one example, two EPs in the confined P2P address range can communicate directly through a PCIe switch associated with the same RP without routing the traffic through a coherent fabric (e.g., coherent fabric 314 of FIG. 3).

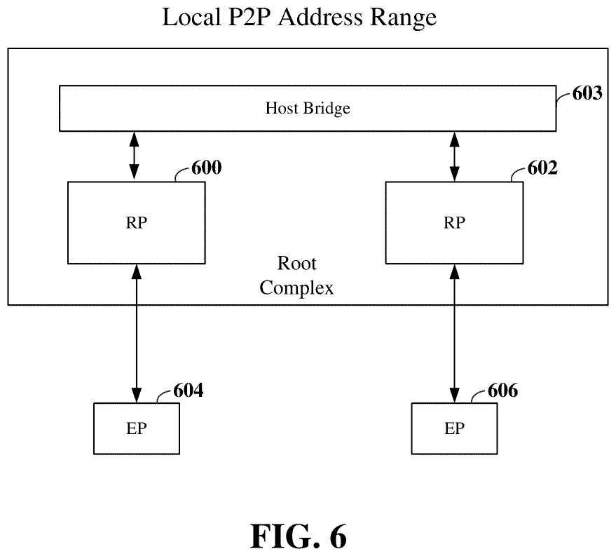

FIG. 6 is a diagram illustrating an exemplary local P2P address range configuration according to some aspects of the disclosure. A Local P2P address range refers to a memory address space that enables P2P communication between PCIe devices that are under different RPs without routing the traffic through a coherent fabric. For example, a local P2P address range maps to a set of RPs (e.g., RPs 600 and 602) behind a single host-bridge 603 (e.g., a PHB) and may share an MMU (e.g., MMU 404 of FIG. 4). The host-bridge 603 can be a part of a PCIe root complex. A local P2P address range can be used for P2P communication between PCIe devices (e.g., EP 604 and 606) connected through different RPs associated with the same PHB. The host bridges 603 and RPs 600 and 602 can correspond to the same root complex. Both the local P2P address range and confined P2P address range define memory-mapped regions that enable P2P communication between PCIe devices (e.g., EPs), but they operate at different hierarchical levels in a PCIe system.

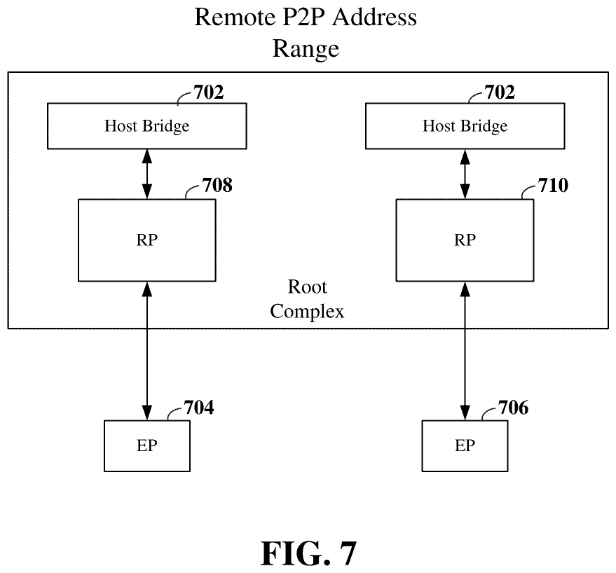

FIG. 7 is a diagram illustrating an exemplary remote P2P address range configuration according to some aspects of the disclosure. A remote P2P address range maps to a set of RPs behind other host bridges 702 not associated with the initiator RP. The remote P2P address range can be used for P2P communication between devices (e.g., EPs 704 and 706) connected through different RPs that belong to different host bridges 702 (e.g., PHBs) that may be on the same die (e.g., chiplet) or across multiple dies or even packaged chips. For example, EP 704 and EP 706 are connected to RP 708 and RP 710 respectively. Here, RP 708 and RP 710 are connected to different PHBs. The host bridges 702 and RPs 708 and 710 can correspond to the same root complex.

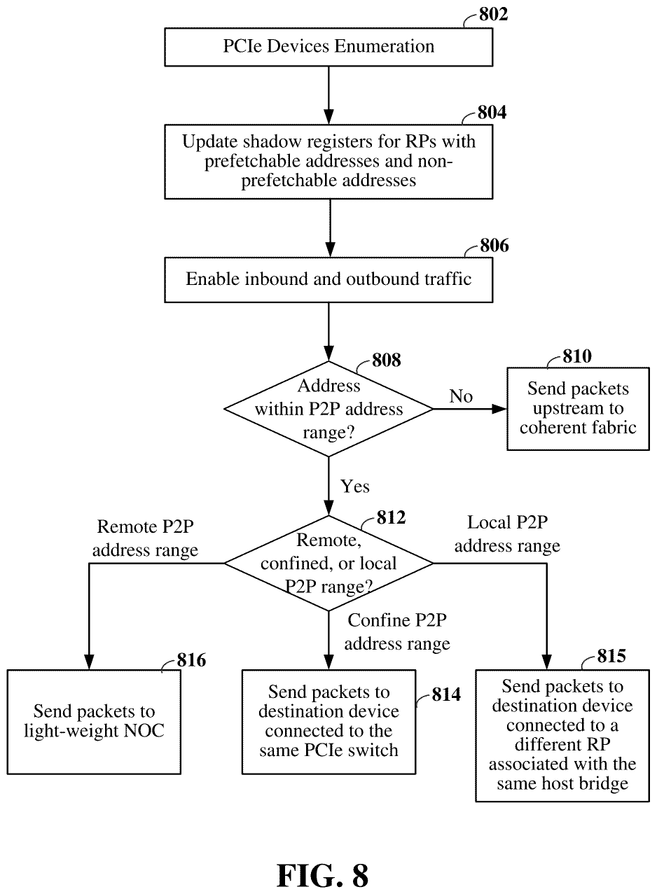

FIG. 8 is a flow chart illustrating an exemplary process 800 for processing P2P traffic according to some aspects of the disclosure. For example, the process 800 can be used to process P2P traffic between PCIe EPs described above in relation to FIGS. 1-7 or any suitable PCIe devices.

At 802, a root complex can perform device enumeration for PCIe devices in a PCIe system. The root complex can initiate the enumeration process during system boot or reset. Device enumeration is a process of discovering, identifying, and configuring PCIe devices connected to the system. For example, the root complex can probe the PCIe hierarchy to detect devices; assigning bus, device, and function numbers to each discovered device; and configure device resources, such as memory and I/O address ranges. In some aspects, the root complex can capture the information regarding other PCIe subsystems and program the corresponding aperture registers so that PCIe transactions can be routed appropriately.

At 804, the PCIe bypass bridge (e.g., P2P bypass bridge 402 of FIG. 4) can update its shadow registers (registers 420 of FIG. 4) for all the RPs with their prefetchable and non-prefetchable addresses. For example, during the enumeration, the P2P bypass bridge can monitor the configuration transaction layer packets to obtain the prefetchable and non-prefetchable address information and other related information. Prefetchable addresses refer to memory regions where the PCIe device allows speculative or prefetching reads by the host (e.g., CPU). The memory in these regions is assumed to have no side effects from read operations and does not require strict ordering. Non-prefetchable addresses refer to memory regions where speculative or prefetching reads are not allowed. The P2P bypass bridge needs to distinguish between prefetchable and non-prefetchable traffic. P2P communication relies on proper mapping of prefetchable and non-prefetchable address ranges within the PCIe fabric.

At 806, once enumeration is complete, the host (e.g., a root complex) can enable the EPs to send PCIe traffic (inbound traffic) to the host, and the host can send PCIe traffic (outbound traffic) to EPs. PCIe traffic can include transaction layer packets. A transaction layer packet (TLP) encapsulates the information needed to perform a variety of operations such as memory reads and writes, I/O transactions, and configuration space accesses. TLPs are the primary mechanism for transferring data, initiating transactions, and performing communication between PCIe devices (e.g., EPs). For example, when inbound memory TLPs are received by a RP, the RP checks the correctness of the TLPs and then passes the information to the PCIe inbound fabric. Then, the MMU can validate and translate the memory access requests encapsulated in the TLPs. For example, the MMU can translate the address in a TLP from the PCIe device's virtual address to the corresponding physical memory address.

At 808, the P2P bypass bridge can check if the mapped physical address is within the P2P address range(s) as tracked in the P2P bypass bridge. For example, the P2P bypass bridge can compare the address to those stored in one or more registers (e.g., registers 420 of FIG. 4). At 810, if the address is outside of the P2P address range, the P2P bypass bridge can send the packet upstream to the coherent fabric for further routing to reach its destination.

At 812, if the physical address is within the P2P address range, the P2P bypass bridge further checks if the physical address is within a confined P2P address range, a local P2P address range, or a remote P2P address range. At 814, if the physical address maps to a confined P2P address range, a PCIe switch (e.g., PCIe switch 502) can send the packet back downstream to the appropriate destination device (e.g., EP) that is connected to the same PCIe switch as the source device that originated the packet. At 815, if the physical address maps to a local P2P address range, a host bridge (e.g., host bridge 603) can send the packet from the source device (e.g., a first EP) back downstream to the appropriate RP that is connected to the destination device (e.g., a second EP). The source device and the destination device are connected to different RPs that are associated with the same host bridge. In both the local and confined P2P address range examples, the packet can bypass the coherent fabric.

At 816, if the physical address maps to a remote P2P address range, the PCIe bypass bridge can send the traffic to a remote RP through a light-weight NOC (e.g., light NOC 322 of FIG. 3) that can bypass the coherent fabric.

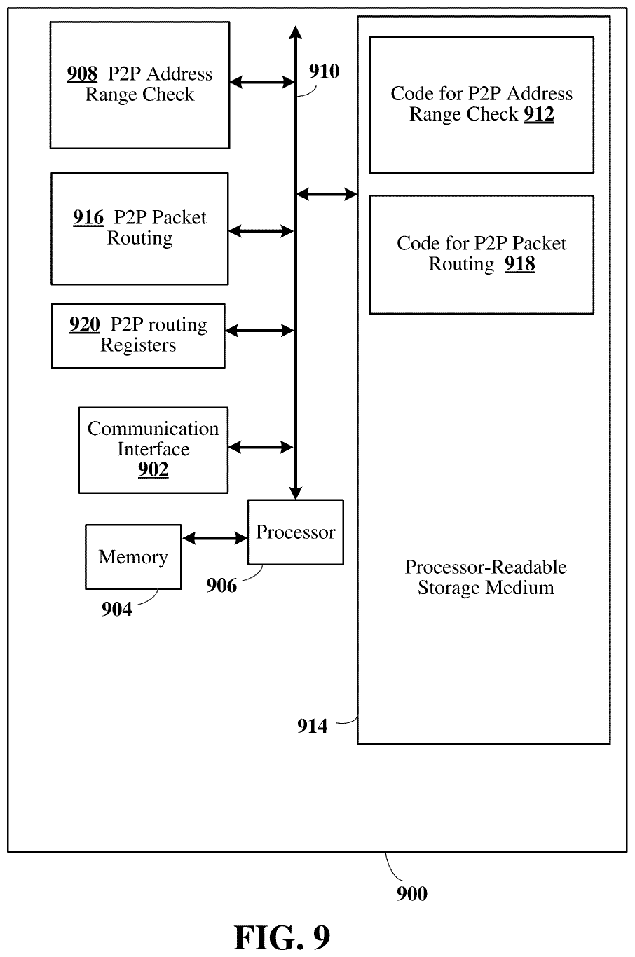

FIG. 9 is a block diagram of an apparatus 900 according to some aspects of the disclosure. The apparatus 900 can be any of the one or more of the devices and components (e.g., I/O subsystem 400 of FIG. 4) described above in relation to FIGS. 1-8. In some examples, the an apparatus 900 can include a P2P bypass bridge. The P2P bypass bridge can be connected to a PCIe fabric and MMU similar to those described in relation to FIGS. 1-8. The apparatus 900 has a communication interface 902 that connects the apparatus to the PCIe fabric and MMU for data communication (e.g., transmitting and receiving PCIe packets). The communication interface 902 enables the apparatus 900 to transmit and receive data packets to and from the PCIe fabric, coherent fabric, and light-weight NOC.

The apparatus 900 further includes one or more memories (e.g., a memory 904) that can be used for storing data and information used by one or more processors (e.g., processor 906) during various operations. In some aspects, the memory 904 can store information and data packets for routing P2P PCIe traffic. In one example, the memory 904 can provide a buffer used for storing copies of PCIe TLPs.

The apparatus 900 can further include P2P address range check circuitry 908 that can be configured to check whether a PCIe data packet has a destination address that is within a P2P address range of a device. The P2P address range check circuitry 908 has access through the bus 910 to code for P2P address range check 912 stored in a process-readable storage medium 914.

The apparatus 900 can further include P2P packet routing circuitry 916 that can be configured to route P2P data packets between a first device and a second device with or without using a coherent fabric. In some aspects, the P2P packet routing circuitry 916 can include a RP and/or a PCIe switch. For example, when the destination address is within the P2P address range of the devices, the P2P packet routing circuitry 916 can route the data packet between the devices via the communication interface 902 and bypass the coherent fabric. The P2P packet routing circuitry 916 has access through the bus 910 to code for P2P packet routing 918 stored in the process-readable storage medium 914.

The apparatus 900 can further include one or more P2P routing registers 920 for storing the memory space range information and apertures of PCIe subsystems, for example, obtained during PCIe device enumeration. The apparatus 900 (e.g., P2P address range check circuitry 908) can use the information in the P2P routing registers to determine whether to route P2P packets though a coherent fabric or not.

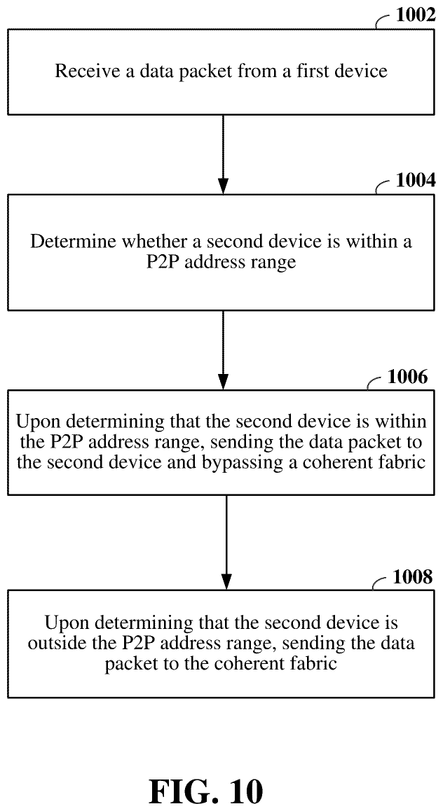

FIG. 10 illustrates a flow diagram of a method 1000 for peer-to-peer (P2P) communication between peer devices according to aspects of the present disclosure. In certain aspects, the method 1000 provides techniques for sending P2P traffic between PCIe devices (e.g., EPs) and bypassing a coherent fabric in certain situation. In some aspects, the method may be adapted to suit data communication other than PCIe communication.

At 1002, the method begins with receiving a data packet from a first device, where the data packet is destined to a second device. In some aspects, the first device and the second device can be PCIe EPs similar to those described above in relation to FIGS. 1-8. In one example, the data packet can be a TLP. In some aspects, the apparatus 900 can provide a means (e.g., communication interface 902) to receive the data packet from the first device.

At 1004, the method continues with determining whether a second device is within a P2P address range. The first device and the second device can be within the same P2P address range. The apparatus 900 can provide a means (e.g., P2P address range check circuitry 908 and P2P routing registers 920) to determine whether the address of the second device (e.g., a PCIe EP) is within a P2P address range. In one example, the address of the second device is within the P2P address range (e.g., a configured P2P address range) of the first device when the first device and the second device are connected to the same PCIe RP. In one example, the address of the second device is within the P2P address range (e.g., a local P2P address range) of the first device when the first device and the second device are connected to different PCIe RPs that are associated with the same PHB. In one example, the address of the second device is within the P2P address range (e.g., a remote P2P address range) of the first device when the first device and the second device are connected to different PCIe RPs that are associated with different PHBs.

At 1006, the method continues with sending the data packet to the second device and bypassing a coherent fabric, upon determining that the second device is within the P2P address range. The apparatus 900 can provide a means (e.g., P2P packet routing circuitry 916) to send the data packet to the second device using the communication interface 902 and bypass the coherent fabric.

At 1008, the method continues with sending the data packet to the coherent fabric, upon determining that the second device is outside the P2P address range. The data packet may reach the second device via the coherent fabric. The apparatus 900 can provide a means (e.g., P2P packet routing circuitry 916) to send the data packet to the second device using the communication interface 902 and the coherent fabric.

The following provides an overview of examples of the present disclosure.

Aspect 1: A method for peer-to-peer (P2P) data communication, the method comprising: receiving a data packet from a first device; determining whether a second device is within a P2P address range; in response to determining that the second device is within the P2P address range, sending the data packet to the second device bypassing a coherent fabric.

Aspect 2: The method of aspect 1, further comprising: in response to determining that the second device is outside the P2P address range, sending the data packet to the coherent fabric.

Aspect 3: The method of aspect 1, further comprising: determining the P2P address range based on information obtained during enumeration of a plurality of peripheral component interconnect express (PCIe) devices including the first device and the second device.

Aspect 4: The method of aspect 1, 2, or 3, wherein the P2P address range comprises at least one of: a confined P2P address range mapped to a memory space comprising a single root port; a local P2P address range mapped a memory space comprising multiple root ports that are associated with a same host bridge; or a remote P2P address range mapped to a memory space comprising multiple root ports that are associated with different host bridges.

Aspect 5: The method of aspect 4, further comprising: sending, without using the coherent fabric, the data packet to the second device, wherein the first device and the second device are in the confined P2P address range.

Aspect 6: The method of aspect 4, further comprising: receiving the data packet from the first device using a first root port; and sending, without using the coherent fabric, the data packet to the second device using a second root port that shares a host bridge with the first root port, wherein the first device and the second device are in the local P2P address range.

Aspect 7: The method of aspect 4, further comprising: receiving the data packet from the first device using a first root port that is associated with a first host bridge; and sending, without using the coherent fabric, the data packet to the second device using a second root port that is associated with a second host bridge that is different from the first bridge, wherein the first device and the second device are in the remote P2P address range.

Aspect 8: The method of aspect 7, further comprising: sending the data packet to the second device using a network-on-chip (NOC) that is configured to connect a first chiplet comprising the first device and a second chiplet comprising the second device.

Aspect 9: An apparatus for data communication, comprising: one or more memories; and one or more processors connected to the one or more memories, the one or more processors configured to: receive a data packet from a first device; determine whether an address associated with a second device is within a peer-to-peer (P2P) address range; in response to determining that the second device is within the P2P address range, send the data packet to the second device bypassing a coherent fabric; and in response to determining that the second device is outside the P2P address range, send the data packet to the coherent fabric.

Aspect 10: The apparatus of aspect 9, further comprising: in response to determining that the second device is outside the P2P address range, send the data packet to the coherent fabric.

Aspect 11: The apparatus of aspect 9, wherein the one or more processors are further configured to: determine the P2P address range based on information obtained during enumeration of a plurality of PCIe devices including the first device and the second device.

Aspect 12: The apparatus of aspect 9, 10, or 11, wherein the P2P address range comprises at least one of: a confined P2P address range mapped to a memory space comprising a single root port; a local P2P address range mapped a memory space comprising multiple root ports that are associated with a same host bridge; or a remote P2P address range mapped to a memory space comprising multiple root ports that are associated with different host bridges.

Aspect 13: The apparatus of aspect 12, wherein the one or more processors are further configured to: send, without using the coherent fabric, the data packet to the second device, wherein the first device and the second device are in the confined P2P address range.

Aspect 14: The apparatus of aspect 12, wherein the one or more processors are further configured to: receive the data packet from the first device using a first root port; and send, without using the coherent fabric, the data packet to the second device using a second root port that shares a host bridge with the first root port, wherein the first device and the second device are in the local P2P address range.

Aspect 15: The apparatus of aspect 12, wherein the one or more processors are further configured to: receive the data packet from the first device using a first root port that is associated with a first host bridge; and send, without using the coherent fabric, the data packet to the second device using a second root port that is associated with a second host bridge that is different from the first host bridge, wherein the first device and the second device are in the remote P2P address range.

Aspect 16: The apparatus of aspect 15, wherein the one or more processors are further configured to: send the data packet to the second device using a network-on-chip (NOC) that is configured to connect a first chiplet comprising the first device and a second chiplet comprising the second device.

Aspect 17: An apparatus for data communication, comprising: means for receiving a data packet from a first device; means for determining whether an address associated with a second device is within a peer-to-peer (P2P) address range; and means for sending the data packet to the second device bypassing a coherent fabric in response to determining that the second device is within the P2P address range.

Aspect 18: The apparatus of aspect 17, further comprising: means for sending the data packet to the coherent fabric in response to determining that the second device is outside the P2P address range.

Aspect 19: The apparatus of aspect 17, further comprising: means for determining the P2P address range based on information obtained during enumeration of a plurality of PCIe devices including the first device and the second device.

Aspect 20: The apparatus of aspect 17, 18, or 19, wherein the P2P address range comprises at least one of: a confined P2P address range mapped to a memory space comprising a single root port. a local P2P address range mapped a memory space comprising multiple root ports that are associated with a same host bridge; or a remote P2P address range mapped to a memory space comprising multiple root ports that are associated with different host bridges.

Aspect 21: The apparatus of aspect 20, further comprising: means for sending, without using the coherent fabric, the data packet to the second device, wherein the first device and the second device are in the confined P2P address range.

Aspect 22: The apparatus of aspect 20, further comprising: means for receiving the data packet from the first device using a first root port; and means for sending, without using the coherent fabric, the data packet to the second device using a second root port that shares a host bridge with the first root port, wherein the first device and the second device are in the local P2P address range.

Aspect 23: The apparatus of aspect 20, further comprising: means for receiving the data packet from the first device using a first root port that is associated with a first host bridge; and means for sending, without using the coherent fabric, the data packet to the second device using a second root port that is associated with a second host bridge that is different from the first host bridge, wherein the first device and the second device are in the remote P2P address range.

It is to be appreciated that the present disclosure is not limited to the exemplary terms used above to describe aspects of the present disclosure. For example, bandwidth may also be referred to as throughput, data rate or another term.

Although aspects of the present disclosure are discussed above using the example of the PCIe standard, it is to be appreciated that present disclosure is not limited to this example, and may be used with other standards.

Any reference to an element herein using a designation e.g. “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A method for peer-to-peer (P2P) data communication, the method comprising:
receiving a data packet from a first device;
determining whether a second device is within a P2P address range; and
in response to determining that the second device is within the P2P address range, sending the data packet to the second device bypassing a coherent fabric.

2. The method of claim 1, further comprising:
in response to determining that the second device is outside the P2P address range, sending the data packet to the coherent fabric.

3. The method of claim 1, further comprising:
determining the P2P address range based on information obtained during enumeration of a plurality of peripheral component interconnect express (PCIe) devices including the first device and the second device.

4. The method of claim 1, wherein the P2P address range comprises at least one of:
a confined P2P address range mapped to a memory space comprising a single root port;
a local P2P address range mapped a memory space comprising multiple root ports that are associated with a same host bridge; or
a remote P2P address range mapped to a memory space comprising multiple root ports that are associated with different host bridges.

5. The method of claim 4, further comprising:
sending, without using the coherent fabric, the data packet to the second device,
wherein the first device and the second device are in the confined P2P address range.

6. The method of claim 4, further comprising:
receiving the data packet from the first device using a first root port; and
sending, without using the coherent fabric, the data packet to the second device using a second root port that shares a host bridge with the first root port,
wherein the first device and the second device are in the local P2P address range.

7. The method of claim 4, further comprising:
receiving the data packet from the first device using a first root port that is associated with a first host bridge; and
sending, without using the coherent fabric, the data packet to the second device using a second root port that is associated with a second host bridge that is different from the first host bridge,
wherein the first device and the second device are in the remote P2P address range.

8. The method of claim 7, further comprising:
sending the data packet to the second device using a network-on-chip (NOC) that is configured to connect a first chiplet comprising the first device and a second chiplet comprising the second device.

9. An apparatus for data communication, comprising:
one or more memories; and
one or more processors connected to the one or more memories, the one or more processors configured to:
receive a data packet from a first device;
determine whether a second device is within a P2P address range; and
in response to determining that the second device is within the P2P address range, send the data packet to the second device bypassing a coherent fabric.

10. The apparatus of claim 9, wherein the one or more processors are further configured to:
in response to determining that the second device is outside the P2P address range, send the data packet to the coherent fabric.

11. The apparatus of claim 9, wherein the one or more processors are further configured to:
determine the P2P address range based on information obtained during enumeration of a plurality of PCIe devices including the first device and the second device.

12. The apparatus of claim 9, wherein the P2P address range comprises at least one of:
a confined P2P address range mapped to a memory space comprising a single root port;
a local P2P address range mapped a memory space comprising multiple root ports that are associated with a same host bridge; or
a remote P2P address range mapped to a memory space comprising multiple root ports that are associated with different host bridges.

13. The apparatus of claim 12, wherein the one or more processors are further configured to:
send, without using the coherent fabric, the data packet to the second device,
wherein the first device and the second device are in the confined P2P address range.

14. The apparatus of claim 12, wherein the one or more processors are further configured to:
receive the data packet from the first device using a first root port; and
send, without using the coherent fabric, the data packet to the second device using a second root port that shares a host bridge with the first root port,
wherein the first device and the second device are in the local P2P address range.

15. The apparatus of claim 12, wherein the one or more processors are further configured to:
receive the data packet from the first device using a first root port that is associated with a first host bridge; and
send, without using the coherent fabric, the data packet to the second device using a second root port that is associated with a second host bridge that is different from the first host bridge,
wherein the first device and the second device are in the remote P2P address range.

16. The apparatus of claim 15, wherein the one or more processors are further configured to:
send the data packet to the second device using a network-on-chip (NOC) that is configured to connect a first chiplet comprising the first device and a second chiplet comprising the second device.

17. An apparatus for data communication, comprising:
means for receiving a data packet from a first device;
means for determining whether a second device is within a P2P address range; and
means for sending the data packet to the second device bypassing a coherent fabric in response to determining that the second device is within the P2P address range.

18. The apparatus of claim 17, further comprising:
means for sending the data packet to the coherent fabric in response to determining that the second device is outside the P2P address range.

19. The apparatus of claim 17, further comprising:
means for determining the P2P address range based on information obtained during enumeration of a plurality of PCIe devices including the first device and the second device.

20. The apparatus of claim 17, wherein the P2P address range comprises at least one of:
a confined P2P address range mapped to a memory space comprising a single root port;
a local P2P address range mapped a memory space comprising multiple root ports that are associated with a same host bridge; or
a remote P2P address range mapped to a memory space comprising multiple root ports that are associated with different host bridges.

21. The apparatus of claim 20, further comprising:
means for sending, without using the coherent fabric, the data packet to the second device,
wherein the first device and the second device are in the confined P2P address range.

22. The apparatus of claim 20, further comprising:
means for receiving the data packet from the first device using a first root port; and
means for sending, without using the coherent fabric, the data packet to the second device using a second root port that shares a host bridge with the first root port,
wherein the first device and the second device are in the local P2P address range.

23. The apparatus of claim 20, further comprising:
means for receiving the data packet from the first device using a first root port that is associated with a first host bridge; and
means for sending, without using the coherent fabric, the data packet to the second device using a second root port that is associated with a second host bridge that is different from the first host bridge,
wherein the first device and the second device are in the remote P2P address range.
